(19) United States
(12) Patent Application Publication
(10) Pub. No.: US 2004/0039618 A1
(43) Pub. Date: Feb. 26, 2004

(54) System for and method of interviewing a candidate

(76) Inventor: Gregorio Cardenas-Vasquez, San Jose, CA (US)

Correspondence Address: MICHAEL BEST & FRIEDRICH, LLP, 100 E WISCONSIN AVENUE, MILWAUKEE, WI, 53202, US

(21) Appl. No.: 09/759,954

(22) Filed: Jan. 12, 2001

Related U.S. Application Data
(60) Provisional application No. 60/175,757, filed on Jan. 12, 2000.

(51) Int. Cl. G06F 17/60

(52) U.S. Cl. 705/7

(57) ABSTRACT

A method of interviewing a candidate for a position of employment via a network. The method includes the acts of establishing at least one firm seeking an agent, establishing a candidate, audibly and visually connecting the candidate with the at least one firm via the network, and performing an interview of the candidate.

This application claims the benefit of provisional patent application entitled ONLINE STREAM RECRUITING, patent application Ser. No. 60/175,757, filed on Jan. 12, 2001, which is incorporated herein by reference.

### BACKGROUND OF THE INVENTION

The invention relates to a system for and a method of interviewing a candidate and, particularly a system for and method of interviewing a candidate via a network.

Traditionally, when a firm (e.g., a corporation, a limited-liability company, a limited-liability partnership, a partnership, etc.) opens a position for hire, the firm posts the position (e.g., in a newspaper) and/or contacts a third party (e.g., a university, a headhunter, etc.) to seek potential candidates. A potential candidate reads the posting or is contacted by the third party. In response, the potential candidate applies for the job by either completing an application and/or submitting a resume. Upon receiving the application and/or resume, the firm reviews the resume and, if satisfied with the application and/or resume, schedules an interview. After completing the interview, the firm may offer the position to the candidate, may request a second interview, or may not pursue the candidate further.

The traditional interview process is unproductive because the first interview, which is typically a general interview, is between only the firm and the candidate. In other words, even though the first interview is a “general” interview, the first interview is one-on-one. This is unproductive for the firm and the candidate.

Another problem with the traditional interview process is that either a representative of the firm, the candidate, or both may be required to travel large distances to meet one another. One solution to this process is to conduct the interview via a telephone. However, this solution has its problems too. For example, the representative of the firm may desire to see the candidate's physical reaction to certain questions.

### SUMMARY OF THE INVENTION

Consequently, it is desirable to have a system for and a method of interviewing a candidate that reduces the time and/or expenses of the firm and/or the candidate. In addition, it is desirable to allow the firm to see at least a portion of the candidate's physical appearance (e.g., the candidate's head) during the interview even if the interview is not performed in person.

Accordingly, the invention provides a method of interviewing a candidate for a position of employment via a communications network. The method includes the acts of establishing at least one firm seeking an agent, establishing a candidate, audibly and visually connecting the candidate with the at least one firm via the network, and performing an interview of the candidate.

The invention also provides a method of interviewing a candidate. The method includes the acts of providing a first terminal controlled by a candidate, the first terminal including a video camera, a microphone and software for operating the first terminal; providing a second terminal controlled by a firm, the second terminal including a display unit, speakers and software for operating the second terminal; providing an intermediary server, the intermediary server including software for operating the intermediary server; and connecting the first terminal with the intermediary server via the network. The method further includes the acts of, at the first terminal, acquiring a communication signal of the candidate representing at least a portion of the candidate in the interview of the candidate and transmitting the communication signal to the intermediary server, and connecting the second terminal with the intermediary server via the network. The method further includes the acts of, at the second terminal, receiving the communication signal representing at least a portion of the candidate in the interview of the candidate, and playing the communication signal.

Other features and advantages of the invention will become apparent to those skilled in the art upon review of the following detailed description, claims, and drawings.

### BRIEF DESCRIPTION OF THE DRAWINGS

FIG. 1 is a schematic diagram of a system embodying the invention.

FIG. 2 is a flowchart of a method of the invention.

FIG. 3 is a flowchart of the act of establishing a firm.

FIG. 4 is a flowchart of the act of establishing a candidate.

FIG. 5 is a flowchart of the act of conducting post event activities.

### DETAILED DESCRIPTION

Before one embodiment of the invention is explained in full detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” and “comprising” and variations thereof herein is meant to encompass the items listed thereafter and equivalents thereof as well as additional items. The terms “connected to” and variations thereof are meant to encompass wire and wireless connections or communications.

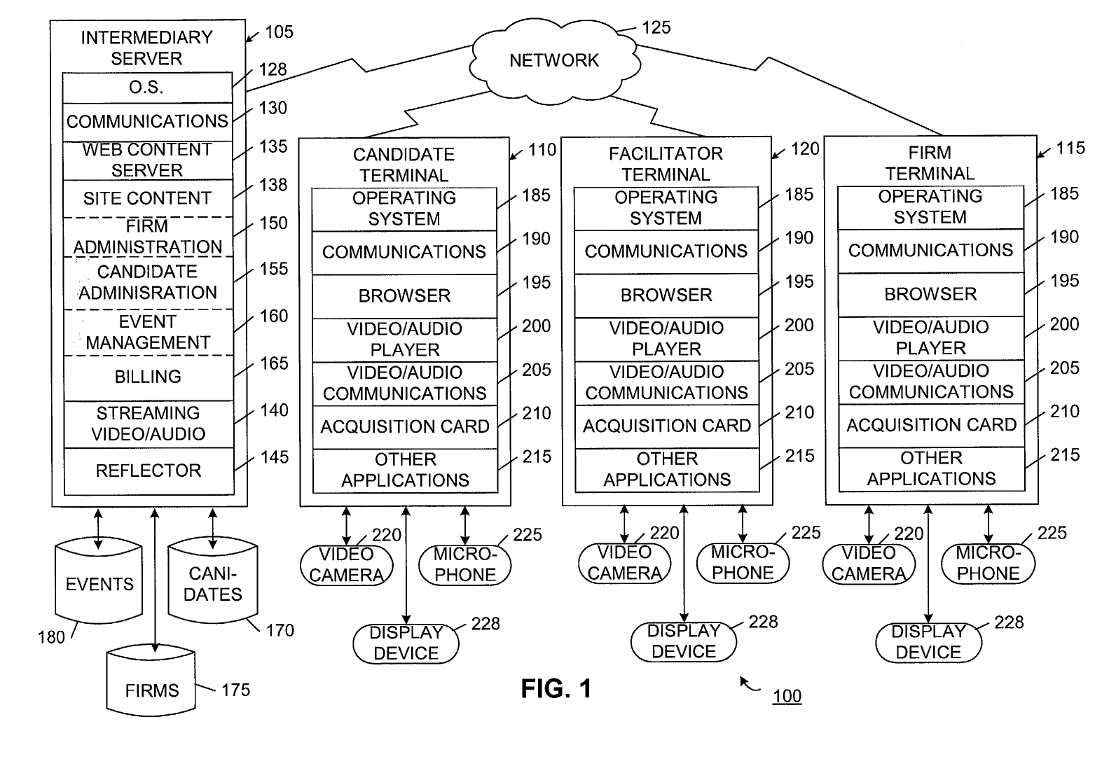

A system 100 of the invention is shown in FIG. 1. The system 100 generally includes an intermediary server 105, a candidate terminal 110, a firm terminal 115, a facilitator terminal 120 and a network 125.

An operator or intermediary operates the intermediary server 105, which includes one or more processors and memory units. The intermediary server 105 provides an Employment Opportunity web site allowing candidates and firms to contact each other and to communicate with each other regarding employment opportunities. Preferably, and as discussed further below, the intermediary server 105 receives compensation from the firm for services the intermediary server 105 performs. Of course, the intermediary may receive compensation from the candidate for services the intermediary server 105 performs.

The intermediary server 105 includes an operating system 128, a communications module 130, a web content server 135, site content 138, a streaming video/audio server 140 and a reflector 145. The operating system 128 includes software that controls the allocation and usage of hardware resources of the intermediary server 105. The communications module includes hardware and associated software for providing communications between the intermediary server 105 and the network 125. The web content server 135 generates the Employment Opportunity web site and includes software that responds to commands from a client terminal (e.g., the candidate terminal, the firm terminal, the recruiter terminal, etc.). The web content server 135 generates the Employment Opportunity web site with content provided by the site content 138. The site content 138 includes a firm administration module 150 for obtaining data from a firm, a candidate administration module 155 for obtaining data from a candidate, an event management module 160 for initiating, maintaining and concluding an interview or event, and a billing module 165 for issuing invoices or accounts receivable. Other functions performed by the site content 138 and modules 150-165 will become apparent in the description below.

The streaming video/audio module 140 includes hardware and associated software for streaming audio and visual signals via the network 125. The reflector 145 promotes videoconferencing communication by sending one or more communication signals to connected terminals upon receipt of the one or more communication signals.

Additional data used by the intermediary server 105 is stored in one or more databases. For the embodiment shown, the intermediary server 105 includes a database of candidates 170, a database of firms 175 and a database of events 180. The database of candidates 170 includes records of each candidate registered with the intermediary server 105. The database of firms 175 includes records of each firm registered with the intermediary server 105. The database of events 180 includes data files for previously recorded interviews or events.

A suitable interediary server 105 for the invention is a Sun Enterprise 420R Server with a Solaris operating system and an Apache Webserver. The suitable intermediary server 105 further includes a Sun Solaria 450 Database Server with a Solaris operating system and a Compaq Prosignia Server 720 intranet server with a Linux operating system.

The intermediary server 105 communicates with established candidates and firms via the network 125. For the embodiment described herein, the network 125 is a packet-switch-based network based on protocols, and may include wire and/or wireless connections. A network suitable for use in the invention is the Internet.

The candidate receives information from and sends information to the intermediary server 105 at a candidate terminal 110. The firm receives information from and sends information to the intermediary server 105 at a firm terminal 115. The candidate terminal 110 and the firm terminal 115 each includes an operating system 185, a communications module 190, a browser 195, a video/audio player module 200, a video/audio communications module 205, an acquisition card 210, other applications 215, a video camera 220, a microphone 225, and display apparatus 228. Although only one candidate terminal 110 and only one firm terminal 115 are shown, the intermediary server 105 may communication with many candidate terminals and firm terminals, and is limited only by the capacity of the intermediary server 105 and the network 125.

The operating system 185 includes software that controls the allocation and use of hardware resources of the respective terminal 110 or 115. The communication module 190 includes hardware and associated software for providing communication between the respective terminal 110 or 115 and the network 125. The browser 195 includes software allowing the respective operator (e.g., the candidate or the firm representative) to view the site content 138 transmitted by the web content server. The video/audio player module 200 includes hardware and/or software for playing audio/video communication-signal-data packets received from the intermediary server 105 via the network 125. The video/audio communications module 205 generates and transmits audio/video communication-signal-data packets to the intermediary server 105 via the network 125. The acquisition card 210 receives analog audio and video signals from the video camera 220 and microphone 225, respectively, and performs. Of course, the intermediary may receive compensation from the candidate for services the intermediary server 105 performs.

The intermediary server 105 includes an operating system 128, a communications module 130, a web content server 135, site content 138, a streaming video/audio server 140 and a reflector 145. The operating system 128 includes software that controls the allocation and usage of hardware resources of the intermediary server 105. The communications module includes hardware and associated software for providing communications between the intermediary server 105 and the network 125. The web content server 135 generates the Employment Opportunity web site and includes software that responds to commands from a client terminal (e.g., the candidate terminal, the firm terminal, the recruiter terminal, etc.). The web content server 135 generates the Employment Opportunity web site with content provided by the site content 138. The site content 138 includes a firm administration module 150 for obtaining data from a firm, a candidate administration module 155 for obtaining data from a candidate, an event management module 160 for initiating, maintaining and concluding an interview or event, and a billing module 165 for issuing invoices or accounts receivable. Other functions performed by the site content 138 and modules 150-165 will become apparent in the description below.

The streaming video/audio module 140 includes hardware and associated software for streaming audio and visual signals via the network 125. The reflector 145 promotes videoconferencing communication by sending one or more communication signals to connected terminals upon receipt of the one or more communication signals.

Additional data used by the intermediary server 105 is stored in one or more databases. For the embodiment shown, the intermediary server 105 includes a database of candidates 170, a database of firms 175 and a database of events 180. The database of candidates 170 includes records of each candidate registered with the intermediary server 105. The database of firms 175 includes records of each firm registered with the intermediary server 105. The database of events 180 includes data files for previously recorded interviews or events.

A suitable interediary server 105 for the invention is a Sun Enterprise 420R Server with a Solaris operating system and an Apache Webserver. The suitable intermediary server 105 further includes a Sun Solaria 450 Database Server with a Solaris operating system and a Compaq Prosignia Server 720 intranet server with a Linux operating system.

The intermediary server 105 communicates with established candidates and firms via the network 125. For the embodiment described herein, the network 125 is a packet-switch-based network based on protocols, and may include wire and/or wireless connections. A network suitable for use in the invention is the Internet.

The candidate receives information from and sends information to the intermediary server 105 at a candidate terminal 110. The firm receives information from and sends information to the intermediary server 105 at a firm terminal 115. The candidate terminal 110 and the firm terminal 115 each includes an operating system 185, a communications module 190, a browser 195, a video/audio player module 200, a video/audio communications module 205, an acquisition card 210, other applications 215, a video camera 220, a microphone 225, and display apparatus 228. Although only one candidate terminal 110 and only one firm terminal 115 are shown, the intermediary server 105 may communication with many candidate terminals and firm terminals, and is limited only by the capacity of the intermediary server 105 and the network 125.

The operating system 185 includes software that controls the allocation and use of hardware resources of the respective terminal 110 or 115. The communications module 190 includes hardware and associated software for providing communications between the respective terminal 110 or 115 and the network 125. The browser 195 includes software allowing the respective operator (e.g., the candidate or the firm representative) to view the site content 138 transmitted by the web content server 135. The video/audio player module 200 includes hardware and/or software for playing audio/video communication-signal-data packets received from the intermediary server 105 via the network 125. The video/audio communications module 205 generates and transmits audio/video communication-signal-data packets to the intermediary server 105 via the network 125. The acquisition card 210 receives analog audio and video signals from the video camera 220 and microphone 225, respectively, and converts the signals into digital audio and video signals, respectively. The other applications 215 include applications not significant for the purpose of the invention.

The facilitator terminal 120 is controlled by an interviewer or facilitator (discussed further below). The facilitator terminal 120 is shown as a stand-alone terminal but, alternatively, may be incorporated within the intermediary server 105. The facilitator terminal 120 includes an operating system 185, a communications module 190, a browser 195, a video/audio player module 200, a video/audio communications module 205, an acquisition card 210, other applications 215, a video camera 220, a microphone 225 and a display apparatus 228.

In one embodiment of the invention, the terminals 110, 115 and 120 are desktop computers. However, the terminals 110, 115 and/or 120 may be kiosks, personal data assistants, hand-held computers, laptop computers, videophones, Internet appliances, and similar devices. Specifically, a suitable terminal is a personal computer having a Windows NT 2000 operating system, a Windows Media server, a RealPlayer server and a Canon XL1 video camera.

In addition, although the terminals 110, 115 and 120 are controlled by their respective users, the terminals do not need to be owned by the user. For example, the candidate terminal 110 may be a kiosk owned by a third party. Specifically, the candidate may be a student and the kiosk may be located at the recruiting office of the candidate's school or university.

Having described the basic architecture of the system 100, its operation will be explained below. The intermediary server 105 has a variety of tools and information that are accessible to users via the network 125. The users include candidates seeking to obtain employment opportunities and firms seeking to hire employees. The intermediary server acts as a “bulletin board” for firms announcing job openings, a “bulletin board” for candidates to disclose their resume, references, capabilities and/or experiences, an “interview room” for a facilitator to interview a candidate while one or more firms watching the event, and an “interview room” for a firm representative to directly interview a candidate. The content site 138 of the intermediary server 105 includes formatted content, such as HTML pages, that is distributed by the Web content server 125. Preferably the site content 138 is configured as an Employment Opportunity web site and is accessible by any terminal 110, 115 or 120 connected to the intermediary server via the network 125.

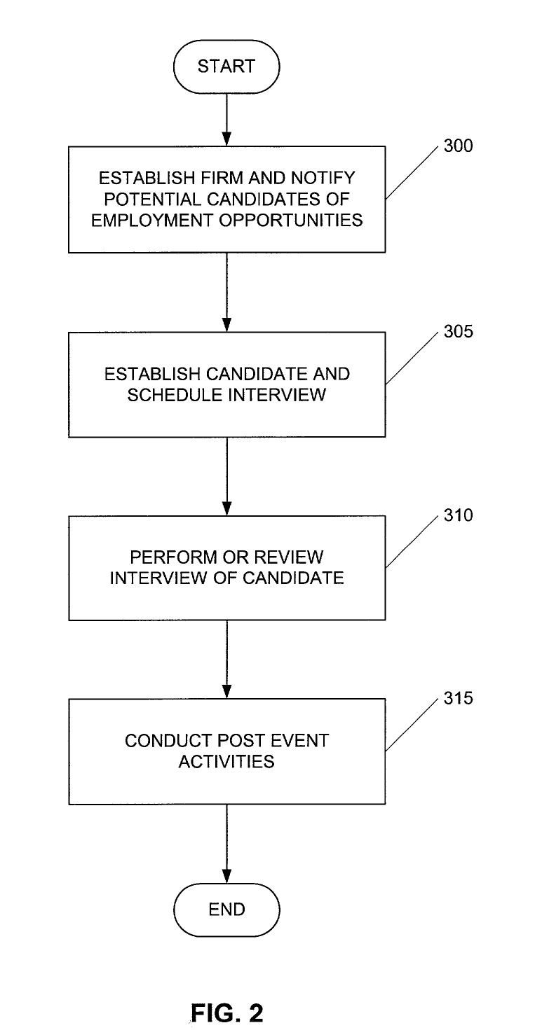

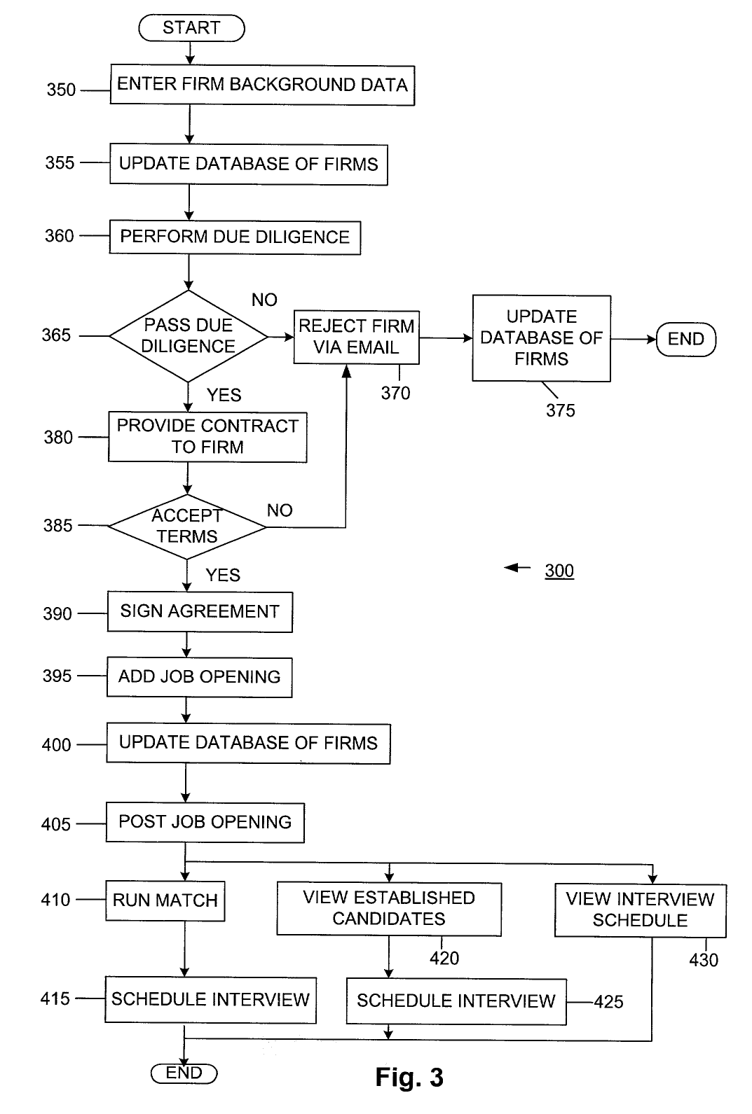

In general and as shown in FIG. 2, one or more firms access the intermediary server 105 and register with the intermediary server 105 (act 300). Once registered, the firm notifies potential candidate of employment opportunities by posting the opportunities via the intermediary server 105. Similarly, one or more candidates access the intermediary server 105 and register with the intermediary server 105 (act 305). Once registered, the candidates notify potential firms of their desire to seek new employment by posting an application and/or resume via the intermediary server 105. In addition to the firm and the candidate posting information, the candidate or firm may seek potential matches with the other entities. Alternatively, the intermediary server 105 may attempt to create matches. Once a match is obtained or if the candidate requests, the candidate performs an initial interview with a facilitator (act 310). The initial interview may be watched live by one or more firms and is recorded for future reviews. This allows for multiple firms to watch the initial interview without having the candidate perform multiple interviews. Upon completion of the initial interview (act 315), one or more firms may attempt to schedule a subsequent second interview. Alternatively, one or more firms may issue an offer of employment to the candidate. In the embodiment shown, the firm pays a transaction fee for the subsequent one-on-one interview or to provide an offer. If the candidate agrees to the subsequent interview, the firm interviews the candidate in a one-on-one interview. If the candidate accepts an offer of employment, a contract is signed. In the embodiment disclosed, the firm pays a signature fee when the candidate signs a contract. Other acts performed by the system and a more detailed description of the method is shown in FIGS. 3, 4 and 5, and is described below. Of course, a number of the acts disclosed may be performed in a different order. For example, the system may establish a candidate before establishing the firm. In addition, not all of the acts may be required for the method. For example, not all of the post event activities need to be performed. Even further, one or more acts may be repeated. For example, any number of firms or candidates may be established (acts 300 and 305).

At act 300, the intermediary server 105 establishes a firm and notifies established candidates of posted employment opportunities. To establish the firm and post employment opportunities, the firm accesses the Employment Opportunity web site and proceeds to the site content 138 relating to firms (i.e., the firm administration module 150).

As shown in FIG. 3 and at act 350, the firm enters background data relating to the firm at the firm terminal 115. For example, the firm may enter data relating to firm office locations, number of employees, type of services rendered or goods sold by the firm, contact information, etc. Upon entering the background data, the data is transmitted to the intermediary server 105 and the intermediary server 105 updates the database of firms 175 (act 355). At act 360, the operator of the intermediary server performs due diligence to confirm that the firm exists and that the data entered by the firm is correctly entered. If the entered data does not pass the due diligence (act 365), then the intermediary server 105 rejects the firm. When rejecting the firm, the intermediary server notifies the firm of the rejection via e-mail and updates the database of firms 175. If the data entered by the firm passes the due diligence, then the intermediary server 105 transmits a contract to the firm terminal 115. The contract is between the intermediary server 105 and the firm, and relates to the use of the intermediary server 105 and costs of services performed by the intermediary server 105. For example, the intermediary server 105 informs the firm of how invoices or account receivables are billed and how payments are to be paid. If the firm does not accept the contract terms (act 385) then the firm is rejected (acts 370 and 375). If the firm accepts the contract terms, then they sign the agreement and fax or mail the agreement to the operator of the intermediary server 105. Alternatively, the firm may sign the agreement with an electronic signature and transmit the signed agreement to the intermediary server 105.

At act 395, the firm enters data relating to one or more job opportunities at the firm terminal 115. The firm enters the opportunities by accessing the Employment Opportunity web site and proceeding to the site content 138 relating to firms (i.e., the firm administration module 150). Upon entering one or more job opportunities, the opportunities are transmitted to the intermediary server and the intermediary server 105 updates the database of firms 175 (act 400). After updating the database of firms 175, the jobs are posted on the intermediary server “bulletin board”. Candidates seeking to interview with employers access the “bulletin board”. In addition, the firm may perform a number of acts to seek a potential candidate.

At act 410, the intermediary server 105 attempts to match candidates registered with the intermediary server 105 with the entered job opportunity. Act 410 may be performed periodically, when the intermediary server 105 receives the job opportunity or when either event occurs. If a match results, then the intermediary server 105 informs the firm and the candidate of the match via the network (e.g., by email). Additionally, the intermediary server 105 attempts to schedule a first or initial interview between the candidate and a facilitator (act 415). If a first interview is scheduled, then the system proceeds to act 310. Alternatively, if a first interview has already been performed with the candidate, then the firm may review the previously performed interview (act 310).

At act 420, the firm views files of previously established candidates posted on the “bulletin board”. If the firm locates a candidate they wish to interview, then the intermediary server 105 informs the candidate of the firm's request and a first interview is scheduled (act 425). If a first interview is scheduled, then the system proceeds to act 310. Alternatively, if a first interview has already been performed with the candidate, then the firm may review the previously performed interview (act 310).

At act 430, the firm reviews the interview schedule of first interviews with candidates. If the firm desires to witness a first interview live, they inform the intermediary server 105. When the interview occurs (act 310), the associated firm terminal 115 is linked with the intermediary server 105 for the event.

At act 305 (FIG. 2), the intermediary server 105 establishes a candidate, notifies established firms of the candidate, and schedules a first interview with the candidate. To establish the candidate, the candidate access the Employment Opportunity web site and proceeds to the site content 138 relating to candidates (i.e., the candidate administration module 155).

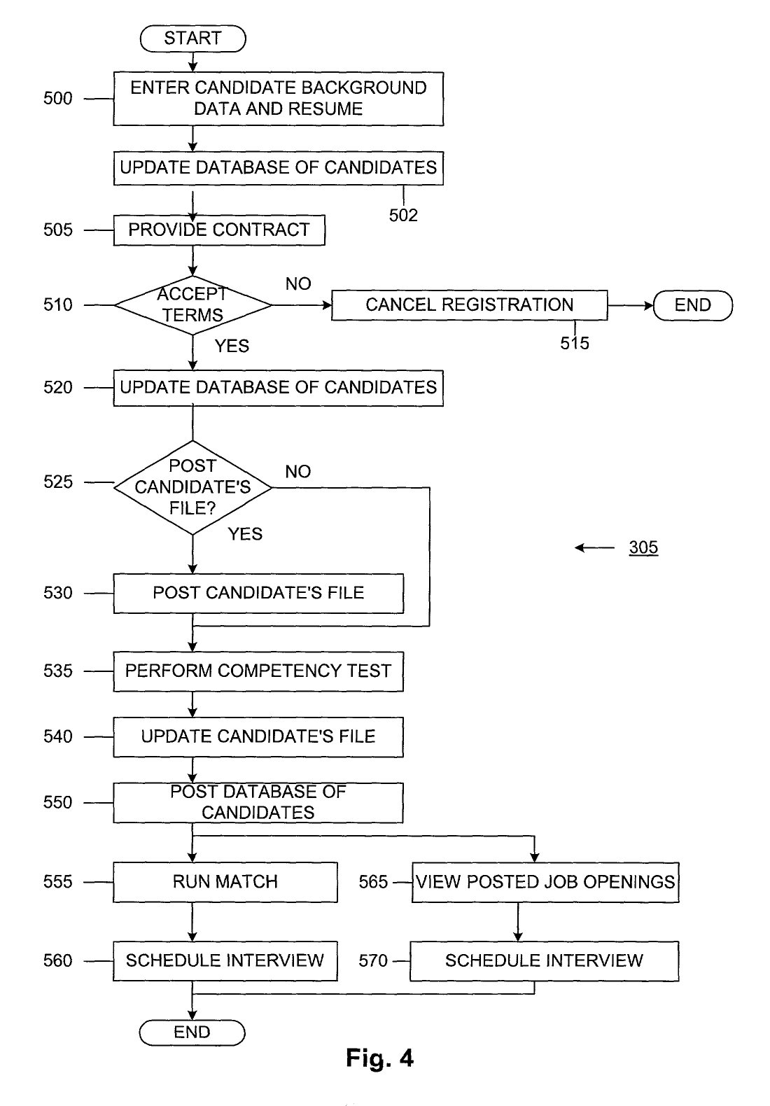

As shown in FIG. 4 and at act 500, the candidate enters background data relating to the candidate at the candidate terminal 120. For example, the candidate may enter data relating to biographical data, job preferences (e.g., location), experience, education, etc. In addition, the candidates may submit a resume or a statement. Upon entering the background data into the candidate terminal, the data is transmitted to the intermediary server 105. The intermediary server 105 updates the database of candidates 170 (act 502) and transmits a contract to the candidate terminal 110 (act 505). The contract is between the intermediary server 105 and the candidate. The contract relates to the use of the intermediary server 105 and to the costs (if any) of services performed by the intermediary server 105. If the candidate does not accept the contract terms (act 510), then the candidate's registration is canceled (acts 515). If the candidate accepts the contract terms, then she signs the agreement, and faxes or mails the agreement to the operator of the intermediary server 105. Alternatively, the candidate may sign the agreement with an electronic signature and transmits the signed agreement to the intermediary server 105.

At act 525, the intermediary server asks whether the candidate would like to post her file at this time. If the candidate answers no, then the system proceeds to act 535. Alternatively, if the candidate answers yes, then the system posts the candidate's file on the “bulletin board” (act 530). At act 535, the intermediary server schedules and performs a competency test with the candidate. Of course, the scheduling and performing of the competency test is not required in all embodiments. For performing the competency test, the test is transmitted from the intermediary server 105 to the candidate terminal 110 via the network 125. The candidate executes the test and the answers are transmitted to the intermediary server 105 via the network. The questions may be transmitted one at a time or, alternatively, multiple questions may be transmitted to the candidate terminal 110 at one time. In addition, the test may include a time limit. Upon completion of the competency test, the intermediary server updates the database of candidates 170 (act 540). Upon updating the candidate's file, the intermediary server posts the candidate's file on the “bulletin board” (act 550). Firms seeking to interview with candidates access the “bulletin board” to view candidates' files. In addition, the candidate may perform a number of acts to seek a potential employer.

At act 555, the intermediary server 105 attempts to match firms registered with the intermediary server 105 with the candidate's preferences. Act 555 may be performed periodically, when the intermediary server 105 posts the candidate or when either event occurs. If a match results, then the intermediary server 105 informs the firm and the candidate of the match via the network 125 (e.g., by email). Additionally, the intermediary server 105 attempts to schedule a first or initial interview between the candidate and a recruiter (act 560).

At act 565, the candidate views posted job openings. If the candidate locates a job opening that she wishes to perform a first interview for, then the intermediary server informs the firm and attempts to schedule an initial interview 570.

After scheduling a first or initial interview, the candidate performs the interview with a facilitator controlling the facilitator terminal 120 (act 310). In one embodiment of the invention, the facilitator performs a one-on-one interview with the candidate. During this interview, one or more firms may watch or witness the interview live. Alternatively, one or more firms may witness the interview at a later date. The first or initial interview is a general interview where the recruiter asks general questions. In alternative embodiments, the firms witnessing the live interview may transmit interview questions to the recruiter for the recruiter to ask.

The interview is performed on a substantial real-time basis. The candidate is able to view at least a portion of the facilitator (e.g., the facilitator's head) at the candidate terminal 110, the facilitator is able to view at least a portion of the candidate (e.g., the candidate's head) at the facilitator terminal 120, and each connected firm is able to view at least a portion of the candidate and/or the facilitator at the firm terminal 115. In addition, the candidate is able to hear the facilitator speak, the facilitator is able to hear the candidate speak, and the firm is able to hear both speak. Lastly, each firm terminal is operable to transmit a question to the facilitator for the facilitator to ask.

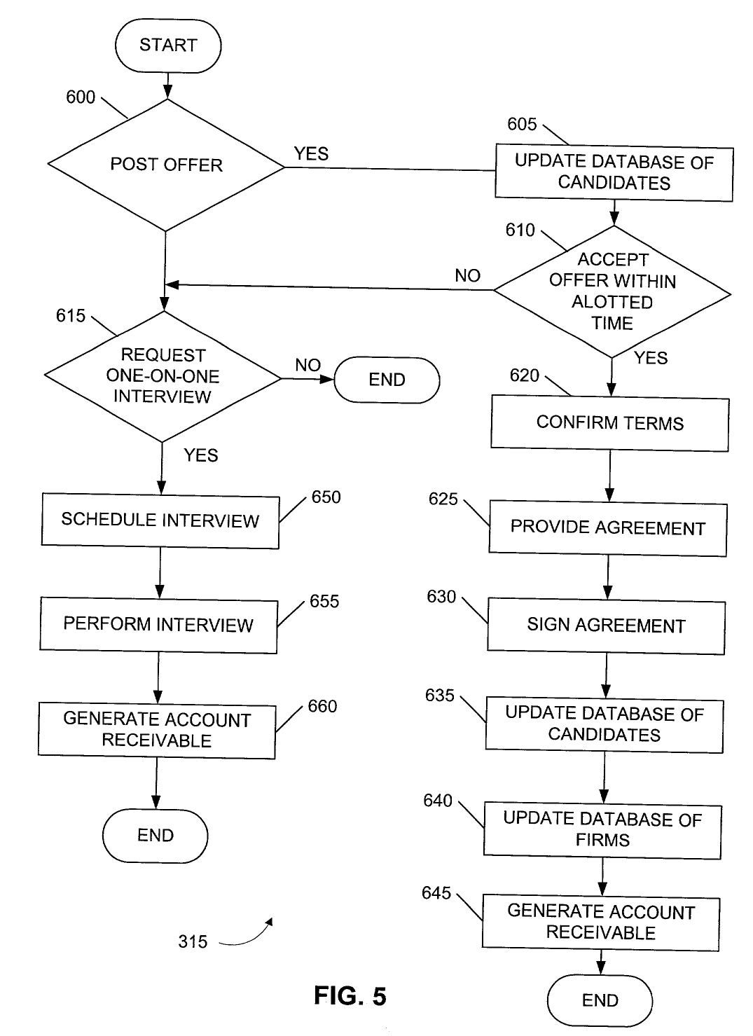

Upon completing the interview, the system conducts post-interview or post-event activities (act 315). As shown in FIG. 5, one or more firms may post (i.e., submit) an offer to the candidate. If an offer is posted, then the intermediary server 105 informs the candidate of the offer (e.g., via email) and updates the database of candidates. The amount of information posted with the offer may vary with different embodiments. For example, the posted offer may include a salary value. Upon seeing the posted salary value, a competing firm may post an offer with a greater salary value. When multiple firms post an offer, the firms may attempt to outbid one another.

At act 610, the candidate must accept an offer within a specified period of time (e.g., one week). The period of time may be set by the intermediary server or, alternatively, set by the posting firm. If the candidate does not accept the offer, then the system proceeds to act 615. Of course, the system may proceed to act 615 prior to the candidate not accepting the offer. If the candidate does accept the offer, then the intermediary server confirms the terms of the offer (act 620), and provides an agreement to the candidate (act 625). The candidate signs the agreement and forwards the agreement to the intermediary server operator (act 630). If the signature is an electronic signature, then the candidate transmits the agreement to the intermediary server 105. The operator of the intermediary server 105 then forwards the agreement to the firm for signature. After both parties sign the agreement, the intermediary server 105 updates the database of candidates 170 by removing the candidate, updates the database of firms 175 by removing the posting, and generates an invoice or accounts receivable (act 645).

At act 615, one or more firms may request a second or subsequent interview with the candidate. If the candidate agrees with the interview, then an interview is scheduled (act 650). The second interview is between the firm and the candidate and is a one-on-one interview (i.e., a representative of the firm asks questions directly to the candidate). For the one-on-one interview, no other firms may witness the interview without approval of the interviewing firm. In another embodiment of the invention, the second interview is recorded allowing the firm to review the interview at a later time. When recording the interview, the interview is stored in the database of events 175. Upon completion of the interview, an account receivable is generated.

As can be seen from the above, the invention provides a system for and method of interviewing a candidate via a network. Various features and advantages of the invention are set forth in the following claims.

What is claimed is:

1. A method of interviewing a candidate for a position of employment via a network, the method comprising the acts of:
establishing at least one firm seeking an agent;
establishing a candidate;
audibly and visually connecting the candidate with the at least one firm via the network;
performing an interview of the candidate.

2. A method as set forth in claim 1 wherein the number of established firms is at least two, wherein the audibly and visually connecting act connects the candidate with at least two firms via the network.

3. A method as set forth in claim 2 and further comprising the act of requesting the candidate to perform a second interview with at least one of the firms.

4. A method as set forth in claim 2 and further comprising performing a second interview with the firm requesting the second interview.

5. A method as set forth in claim 2 and further comprising receiving payment from each of the firms requesting the candidate to perform a second interview.

6. A method as set forth in claim 1 and further comprising submitting at least one offer of employment to the candidate.

7. A method as set forth in claim 6 and further comprising accepting one of the at least one offer of employment.

8. A method as set forth in claim 6 and further comprising receiving payment from each of the firms requesting the candidate to perform a second interview.

9. A method of interviewing a candidate, the method comprising the acts of:
providing a first terminal controlled by a candidate, the first terminal including a video camera, a microphone and software for operating the first terminal;
providing a second terminal controlled by a firm, the second terminal including a display unit, speakers and software for operating the second terminal;
providing an intermediary server, the intermediary server including software for operating the intermediary server;
connecting the first terminal with the intermediary server via the network;
at the first terminal,
acquiring a communication signal of the candidate representing at least a portion of the candidate in the interview of the candidate, and
transmitting the communication signal to the intermediary server;
connecting the second terminal with the intermediary server via the network; and
at the second terminal,
receiving the communication signal representing at least a portion of the candidate in the interview of the candidate, and
playing the communication signal.

10. A method as set forth in claim 9 wherein the connecting acts result in the first and second terminals being connected with the intermediary server at the same time, and wherein the acquiring act and the playing act occur at substantially the same time.

11. A method as set forth in claim 9 wherein the firm controlling the second terminal is a first firm, and the method further comprises the acts of:
providing a third terminal controlled by a second firm, the third terminal including a display unit, speakers and software for operating the second terminal;
connecting the third terminal with the intermediary server via the network; and
at the third terminal
receiving the communication signal representing at least a portion of the candidate in the interview of the candidate, and
playing the communication signal.

12. A method as set forth in claim 11 wherein the connecting acts result in the first and second terminals being connected with the intermediary server at the same time, and wherein the acquiring act and the playing acts occur at substantially the same time.

13. A method as set forth in claim 9 wherein the communication signal is a first communication signal, wherein the first terminal further includes a display unit and speakers, and the method further comprises the acts of:
providing a fourth terminal controlled by a facilitator, the fourth terminal including a video camera, a microphone, and software for operating the fourth terminal;
connecting the fourth terminal with the intermediary server via the network;
at the fourth terminal
receiving the first communication signal representing at least a portion of the candidate in the interview of the candidate,
playing the first communication signal,
acquiring a second communication signal of the facilitator representing at least a portion of the facilitator in the interview of the candidate, and
transmitting the second communication signal to the intermediary server; and
at the first terminal
receiving the second communication signal representing at least a portion of the interviewer in the interview of the candidate, and
playing the second communication signal.

14. A method as set forth in claim 13 and further comprising the acts of:
at the second and third terminals
receiving the second communication signal representing at least a portion of the facilitator in the interview of the candidate, and
playing the second communication signal.

15. A method as set forth in claim 14 wherein the connecting acts result in the first, second, third and fourth terminals being connected with the intermediary server at the same time, and wherein the acquiring acts and the playing acts occur at substantially the same time.

16. A method as set forth in claim 9, wherein the intermediary server further includes a storage device and the method comprises the acts of:
at the intermediary server
receiving the communication signal representing at least a portion of the candidate in the interview of the candidate,
storing the communication signal in the storage device, and
transmitting the communication signal to the second terminal.
